(19) United States
(12) Patent Application Publication
(10) Pub. No.: US 2026/0008929 A1
(43) Pub. Date: Jan. 8, 2026

(54) INK-JET INK OPTIMIZED IN TERMS OF COMPOSITION, ACID VALUE, WEIGHT AVERAGE MOLECULAR WEIGHT, PERCENTAGE OF NEUTRALIZATION, AND CROSS-LINKED STRUCTURE OF SPECIFIC RESIN AND N-OCTANOL/WATER PARTITION COEFFICIENT AND CONTENT OF SPECIFIC ORGANIC SOLVENT, AND METHOD FOR PRODUCING INK-JET INK

(71) Applicant: KYOCERA Document Solutions Inc., Osaka (JP)

(72) Inventor: Tomoaki AONO, Osaka (JP)

(73) Assignee: KYOCERA Document Solutions Inc., Osaka (JP)

(21) Appl. No.: 19/253,734

(22) Filed: Jun. 28, 2025

(30) Foreign Application Priority Data
Jul. 5, 2024 (JP) 2024-109025

(51) Int. Cl. C09D 11/322

(52) U.S. Cl. CPC C09D 11/322

(57) ABSTRACT

An ink-jet ink contains an aqueous vehicle, pigment particles containing a pigment and a dispersion resin, and a specific organic solvent. The dispersion resin is a cross-linked product made of: a neutralized product of a specific resin obtained by copolymerizing, in 100 parts by mass of a predetermined solvent, 1 to 65 parts by mass of α-methylstyrene monomer, 1 to 50 parts by mass of styrene monomer, 10 to 40 parts by mass of (meth)acrylic acid monomer, and 1 to 10 parts by mass of non-ionic monomer; and an epoxy group-containing cross-linking agent. The specific resin has an acid value of 50 to 300 mgKOH/g, a weight average molecular weight of 3000 to 18000, and a percentage of neutralization of 20% to 100%. The specific organic solvent has a LogP of 0 to 0.55 exclusive and a content of the specific organic solvent is 25.0% to 35.0% by mass.

### INCORPORATION BY REFERENCE

This application claims priority to Japanese Patent Application No. 2024-109025 filed on 5 Jul. 2024, the entire contents of which are incorporated by reference herein.

### BACKGROUND

The present disclosure relates to ink-jet inks and methods for producing ink-jet inks.

Generally, an ink-jet ink containing a pigment and an aqueous vehicle is used for an ink-jet printer. In the ink-jet printer as just described, the recording head may cause nozzle clogging due to aggregation or sedimentation of the pigment. As a technique aimed at reducing the occurrence of nozzle clogging just above, there is known a technique in which a pigment is dispersed in a dispersion resin to increase the dispersion stability of the pigment.

For example, a general first technique is known in which a dispersion resin used is a copolymer containing: a building block derived from an aromatic group-containing monomer, such as a styrene-based monomer, an aromatic group-containing acrylate or a styrene-based macromonomer; a building block derived from a carboxy group-containing vinyl monomer, such as acrylic acid or methacrylic acid; and a building block derived from a non-ionic monomer.

For another example, a general second technique is known in which a dispersion resin used is a copolymer having: a first unit derived from a monomer having an aromatic ring; a second unit derived from at least one monomer selected from the group consisting of a monomer having an acid group, a monomer having a hydroxy group, and a monomer having a —(O—R1)n-O— structure, and a sulfonic acid group as an end group.

For the purpose of improving the print quality of ink-jet printers, there is demand for development of an ink having high storage stability. As an ink meeting this demand, for example, a general water-based ink is known which contains: a first water-soluble solvent having a partition coefficient LogP of not less than 0 and less than 1; a second water-soluble solvent having a partition coefficient LogP of less than 0; 1,2-octanediol; and sorbitol and has a viscosity of 5.0 mPa·s or more.

### SUMMARY

A technique improved over the aforementioned techniques is proposed as one aspect of the present disclosure.

An ink-jet ink according to an aspect of the present disclosure contains an aqueous vehicle, pigment particles dispersed in the aqueous vehicle, and a specific organic solvent. The pigment particle contains a pigment and a dispersion resin. The dispersion resin is a cross-linked product made of: a neutralized product of a specific resin obtained by copolymerizing, in 100 parts by mass of a predetermined solvent, not less than 1 part by mass and not more than 65 parts by mass of α-methylstyrene monomer, not less than 1 part by mass and not more than 50 parts by mass of styrene monomer, not less than 10 parts by mass and not more than 40 parts by mass of acrylic acid monomer or methacrylic acid monomer, and not less than 1 part by mass and not more than 10 parts by mass of non-ionic monomer; and an epoxy group-containing cross-linking agent. The specific resin has an acid value of not less than 50 mgKOH/g and not more than 300 mgKOH/g. The specific resin has a weight average molecular weight of not less than 3000 and not more than 18000. The specific resin has a percentage of neutralization of not less than 20% and not more than 100%. The specific organic solvent has an n-octanol/water partition coefficient of not less than 0 and less than 0.55. A content of the specific organic solvent in the ink-jet ink is not less than 25.0% by mass and not more than 35.0% by mass.

A method for producing an ink-jet ink according to another aspect of the present disclosure includes a synthesis step, a neutralization step, a dispersion step, a cross-linking step, and an addition step. In the synthesis step, not less than 1 part by mass and not more than 65 parts by mass of α-methylstyrene monomer, not less than 1 part by mass and not more than 50 parts by mass of styrene monomer, not less than 10 parts by mass and not more than 40 parts by mass of acrylic acid monomer or methacrylic acid monomer, and not less than 1 part by mass and not more than 10 parts by mass of non-ionic monomer are copolymerized in 100 parts by mass of a predetermined solvent, thus synthesizing a specific resin. In the neutralization step, the specific resin is neutralized to have a percentage of neutralization of not less than 20% and not more than 100%. In the dispersion step, a pigment and the neutralized specific resin are dispersed into water, thus preparing a dispersion liquid of pigment particles. In the cross-linking step, an epoxy group-containing cross-linking agent is added into the dispersion liquid of pigment particles, thus cross-linking the specific resin. In the addition step, an aqueous vehicle and a specific organic solvent having an n-octanol/water partition coefficient of not less than 0 and less than 0.55 are added into the dispersion liquid of pigment particles after undergoing the cross-linking step to give a content of the specific organic solvent of not less than 25.0% by mass and not more than 35.0% by mass.

### DETAILED DESCRIPTION

Hereinafter, a description will be given of an ink-jet ink (hereinafter, referred to simply as an “ink”) according to an embodiment of the present disclosure and a method for producing the ink.

In the following description, “acrylic” and “methacrylic” may be referred to collectively as “(meth)acrylic”, and “acrylate” and “methacrylate” may be referred to collectively as “(meth)acrylate”.

Furthermore, a compound and its derivatives may be referred to collectively as a term in which a word “-based” is placed just after the name of the compound. When a copolymer name is represented by placing the word “-based” just after the name of a compound, this means that a repeating unit of the copolymer is derived from the compound or any derivative of the compound.

In this embodiment, the acid value refers to a value determined according to the method described in JIS (Japanese Industrial Standards) K 0070:1992.

The measured value of the weight average molecular weight (Mw) refers to a value measured using gel permeation chromatography.

The percentage of neutralization of a resin refers to the percentage of MB with respect to MA (100×MB/MA) where MA represents a theoretical value of the amount of basic compound necessary to fully neutralize the resin and MB represents the actual amount of basic compound used.

The n-octanol/water partition coefficient (LogP) refers to a value measured by the shake flask method described in JIS Z 7260-107:2000.

The volume median diameter (D50) refers to a value measured with a dynamic light scattering particle size distribution analyzer (“Zetasizer Nano ZS” manufactured by Malvern Instruments, Ltd.).

The epoxy equivalent refers to a value determined according to the method described in JIS K 7236:2009.

The viscosity of ink means the viscosity thereof at 25° C. The measured value of the viscosity refers to a value measured in conformity with the method described in JIS Z 8803:2011 (Methods for viscosity measurement of liquid).

Each of evaluation results (values representing the shape, physical properties or so on) about powder refers to the number average of values obtained by measuring a considerable number of particles, unless otherwise specified.

### Ink-Jet Ink

The ink-jet ink according to this embodiment contains an aqueous vehicle, pigment particles dispersed in the aqueous vehicle, and a specific organic solvent. The pigment particle contains a pigment and a dispersion resin.

The dispersion resin is a cross-linked product made of: a neutralized product of a specific resin obtained by copolymerizing, in 100 parts by mass of a predetermined solvent, not less than 1 part by mass and not more than 65 parts by mass of α-methylstyrene monomer, not less than 1 part by mass and not more than 50 parts by mass of styrene monomer, not less than 10 parts by mass and not more than 40 parts by mass of acrylic acid monomer or methacrylic acid monomer, and not less than 1 part by mass and not more than 10 parts by mass of non-ionic monomer; and an epoxy group-containing cross-linking agent.

The specific resin has an acid value of not less than 50 mgKOH/g and not more than 300 mgKOH/g. The specific resin has a weight average molecular weight (Mw) of not less than 3000 and not more than 18000. The specific resin has a percentage of neutralization of not less than 20% and not more than 100%.

The specific organic solvent has an n-octanol/water partition coefficient (LogP) of not less than 0 and less than 0.55. In the ink according to this embodiment, the content of the specific organic solvent is not less than 25.0% by mass and not more than 35.0% by mass.

Meanwhile, in the compositions of the dispersion resins in the general first and second techniques described previously, the initial dispersibility and dispersion stability are insufficient and, therefore, the occurrence of nozzle clogging may not be able to be sufficiently reduced. Furthermore, in the composition of the general water-based ink described previously, the decrease in ink viscosity may not be able to be sufficiently reduced and, therefore, the ink may not be able to obtain sufficient storage stability.

Unlike the above general techniques and water-based ink, since the ink according to this embodiment has the above-described composition and features, it can reduce the occurrence of nozzle clogging and has excellent storage stability. The reasons why the ink according to this embodiment exerts these effects will be described below.

Generally, in order to reduce the occurrence of nozzle clogging, it is effective to give the pigment particles high dispersion stability. Although, as described above, the pigment particle contains a pigment and a dispersion resin, the pigment alone has low dispersibility in aqueous vehicle. Therefore, in order to give the pigment particles high dispersion stability, it is necessary to increase the dispersion stability of the dispersion resin.

The present discloser conducted intensive studies for increasing the dispersion stability of the dispersion resin and, as a result, found that when the composition of monomers as source materials for the specific resin and the acid value, weight average molecular weight (Mw), and percentage of neutralization of the specific resin are within the above-described respective ranges of values and, in addition, the dispersion resin is given a cross-linked structure derived from an epoxy group-containing cross-linking agent having a high water solubility, the pigment particles can exert excellent dispersion stability in aqueous vehicle and, therefore, the occurrence of nozzle clogging can be reduced.

Furthermore, the present discloser conducted intensive studies for increasing the storage stability of ink and, as a result, found that when the n-octanol/water partition coefficient (LogP) and content of the specific organic solvent are within the above-described respective ranges of values, the decrease in ink viscosity can be reduced and, thus, the ink can achieve high storage stability.

The usage of the ink according to this embodiment is not particularly limited, but, for example, the ink can be used for image formation on permeable recording media or non-permeable recording media. The ink according to this embodiment is suitable for image formation on permeable recording media. The permeable recording media have excellent ink penetration. Examples of the permeable recording media include printing paper and media made from fibers, such as fabrics. Examples of printing paper include plain paper, copy paper, recycled paper, thin paper, paperboard, and glossy paper.

Hereinafter, a detailed description will be given of components of the ink according to this embodiment. Each of the components described below may be used as a single type of material or in combination of two or more types of materials.

### [Aqueous Vehicle]

The aqueous vehicle is a vehicle containing water. The aqueous vehicle may function as a solvent or a dispersion medium. A specific example of the aqueous vehicle is an aqueous vehicle containing water and a water-soluble organic solvent.

### (Water)

The content of water in the ink according to this embodiment is preferably not less than 25.0% by mass and not more than 80.0% by mass, and more preferably not less than 35.0% by mass and not more than 60.0% by mass.

### (Water-Soluble Organic Solvent)

Examples of the water-soluble organic solvent include a glycol compound, a triol compound, a glycol ether compound, a lactam compound, a nitrogen-containing compound, an acetate compound, thiodiglycol, and dimethylsulfoxide.

Examples of the glycol compound include ethylene glycol, 1,3-propanediol, propylene glycol, 1,2-pentanediol, 1,5-pentanediol, 1,2-octanediol, 1,8-octanediol, 3-methyl-1,3-butanediol, 3-methyl-1,5-pentanediol, diethylene glycol, triethylene glycol, tetraethylene glycol, and 2-ethyl-1,2-hexanediol. Among them, the preferred glycol compounds are ethylene glycol, diethylene glycol, 2-ethyl-1,2-hexanediol, 3-methyl-1,5-pentanediol, 1,3-propanediol, 1,5-pentanediol, and propylene glycol.

Examples of the triol compound include glycerin and 1,2,3-butanetriol.

Examples of the glycol ether compound include diethyl diglycol, diethylene glycol monobutyl ether, ethylene glycol monomethyl ether, ethylene glycol monobutyl ether, diethylene glycol monomethyl ether, diethylene glycol monoethyl ether, diethylene glycol diethyl ether (diethyl diglycol), triethylene glycol monomethyl ether, triethylene glycol monoethyl ether, triethylene glycol monobutyl ether, and propylene glycol monomethyl ether. Among them, the preferred glycol ether compound is triethylene glycol monobutyl ether.

Examples of the lactam compound include 2-pyrrolidone and N-methyl-2-pyrrolidone. Among them, the preferred lactam compound is 2-pyrrolidone.

Examples of the nitrogen-containing compound include 1,3-dimethyl imidazolidinone, formamide, and dimethyl formamide.

An example of the acetate compound is diethylene glycol monoethyl ether acetate.

The preferred water-soluble organic solvent is a glycol compound, a triol compound, a glycol ether compound or a lactam compound, and the more preferred water-soluble organic solvent is a mixed solvent formed by mixing in any one of the following Combinations (i) to (iv).
Combination (i): ethylene glycol and diethyl diglycol
Combination (ii): glycerin, triethylene glycol monobutyl ether, 3-methyl-1,5-pentanediol, and 2-pyrrolidone
Combination (iii): triethylene glycol monobutyl ether, 2-pyrrolidone, 1,3-propanediol, and 1,5-pentanediol
Combination (iv): 3-methyl-1,5-pentanediol, 1,2,3-butanetriol, 2-ethyl-1,2-hexanediol, and propylene glycol

The content of water-soluble organic solvent in the ink according to this embodiment is preferably not less than 15.0% by mass and not more than 50.0% by mass, and more preferably not less than 30.0% by mass and not more than 40.0% by mass.

### [Pigment Particles]

As described previously, the pigment particle contains a pigment and a dispersion resin covering the pigment. Specifically, the pigment particle is constituted by: a core containing a pigment; and a dispersion resin that covers the core. The total content of pigment and dispersion resin in the pigment particle is preferably not less than 90% by mass and more preferably 100% by mass.

From the viewpoint of optimizing the color density, hue or stability of the ink according to this embodiment, the volume median diameter of the pigment particles is preferably not less than 30 nm and not more than 200 nm, and more preferably not less than 80 nm and not more than 140 nm.

The content of pigment particles in the ink according to this embodiment is preferably not less than 5.0% by mass and not more than 30.0% by mass, and more preferably not less than 8.0% by mass and not more than 15.0% by mass. When the content of pigment particles is not less than 5.0% by mass, the ink according to this embodiment enables easy formation of an image having a desired image density. Furthermore, when the content of pigment particles is not more than 30.0% by mass, the ink according to this embodiment can be optimized in terms of fluidity.

### (Pigment)

Examples of the pigment include a yellow pigment, an orange-colored pigment, a red pigment, a blue pigment, a violet pigment, and a black pigment. Examples of the yellow pigment include C.I. Pigment Yellows (74, 93, 95, 109, 110, 120, 128, 138, 139, 151, 154, 155, 173, 180, 185, and 193). Examples of the orange-colored pigment include C.I. Pigment Oranges (34, 36, 43, 61, 63, and 71). Examples of the red pigment include C.I. Pigment Reds (122 and 202). An example of the blue pigment is C.I. Pigment Blue (15, and more specifically 15:3). Examples of the violet pigment include C.I. Pigment Violets (19, 23, and 33). An example of the black pigment is C.I. Pigment Black (7).

The content of pigment in the ink according to this embodiment is preferably not less than 3.0% by mass and not more than 20.0% by mass, and more preferably not less than 7.0% by mass and not more than 12.0% by mass. The content of pigment in the pigment particle is preferably not less than 50% by mass and not more than 90% by mass, and more preferably not less than 70% by mass and not more than 80% by mass.

### [Dispersion Resin]

As described previously, the dispersion resin is a cross-linked product made of a neutralized product of a specific resin and an epoxy group-containing cross-linking agent. For example, the dispersion resin covers the pigment in the pigment particles.

### (Specific Resin)

As described previously, the specific resin is a resin obtained by copolymerizing, in 100 parts by mass of a predetermined solvent, not less than 1 part by mass and not more than 65 parts by mass of α-methylstyrene monomer, not less than 1 part by mass and not more than 50 parts by mass of styrene monomer, not less than 10 parts by mass and not more than 40 parts by mass of acrylic acid monomer or methacrylic acid monomer, and not less than 1 part by mass and not more than 10 parts by mass of non-ionic monomer.

The non-ionic monomer is at least one selected from among polyethylene glycol (meth)acrylate (n=1 to 9) and polypropylene glycol (meth)acrylate (n=1 to 9).

In other words, the specific resin is a copolymer having first repeating units derived from α-methylstyrene monomer, second repeating units derived from styrene monomer, third repeating units derived from (meth)acrylic acid monomer, and fourth repeating units derived from a non-ionic monomer.

In the specific resin, the content of the first repeating unit relative to 100% by mass of all the repeating units is preferably not less than 1.0% by mass and not more than 65.0% by mass, and more preferably not less than 20.0% by mass and not more than 65.0% by mass. When the content of the first repeating unit is not less than 1% by mass and not more than 65% by mass, the affinity of the dispersion resin with the pigment can be moderately increased.

In the specific resin, the content of the second repeating unit relative to 100% by mass of all the repeating units is preferably not less than 1.0% by mass and not more than 50.0% by mass, and more preferably not less than 1.0% by mass and not more than 30.0% by mass. When the content of the second repeating unit is within the above range of values, the dispersion resin can be given moderate hydrophobicity to optimize the dispersion stability of the pigment particles.

In the specific resin, the content of the third repeating unit relative to 100% by mass of all the repeating units is preferably not less than 10.0% by mass and not more than 40.0% by mass. When the content of the third repeating unit is within the above range of values, the specific resin can be given a moderate acid value and a cross-linked structure can be moderately introduced into the dispersion resin.

In the specific resin, the content of the fourth repeating unit relative to 100% by mass of all the repeating units is preferably not less than 1.0% by mass and not more than 10.0% by mass. When the content of the fourth repeating unit is within the above range of values, the dispersion resin can be given moderate hydrophilicity to optimize the dispersion stability of the pigment particles.

The specific resin may be a random copolymer or a block copolymer. Among them, the preferred specific resin is a random copolymer.

The acid value of the specific resin is, as described previously, not less than 50 mgKOH/g and not more than 300 mgKOH/g, and preferably not less than 75 mgKOH/g and not more than 275 mgKOH/g. When the acid value of the specific resin is not less than 50 mgKOH/g, a cross-linked structure can be easily introduced by an epoxy group-containing cross-linking agent. When the acid value of the specific resin is not more than 300 mgKOH/g, the dispersion stability of the pigment particles can be optimized.

The weight average molecular weight (Mw) of the specific resin is, as described previously, not less than 3000 and not more than 18000, and preferably not less than 5000 and not more than 15000. When the weight average molecular weight (Mw) of the specific resin is within the above range of values, the dispersion resin can efficiently cover the pigment particles and the separation of the dispersion resin from the pigment particles can be reduced. In addition, the ink viscosity can be prevented from being excessively high and can be controlled within an appropriate range of values.

As described previously, the percentage of neutralization of the specific resin is not less than 20% and not more than 100%. When the percentage of neutralization of the specific resin is within the above range of values, the dispersion resin can be given moderate hydrophilicity to optimize the dispersion stability of the pigment particles.

The specific resin preferably contains alkali metal atoms. Specifically, the specific resin is preferably neutralized with a neutralizer containing alkali metal atoms. The alkali metal atoms are not volatilized even when the ink according to this embodiment is exposed to a dry condition. Therefore, since the specific resin is neutralized with a neutralizer containing alkali metal atoms, the neutralized state (hydrophilicity) of the dispersion resin is maintained even when the ink according to this embodiment is exposed to a dry condition. The preferred alkali metal atoms are potassium atoms or sodium atoms. The preferred neutralizer is a hydroxide containing alkali metal atoms and the more preferred neutralizer is NaOH or KOH.

### (Epoxy Group-Containing Cross-Linking Agent)

The epoxy group-containing cross-linking agent has, in its molecule, at least one epoxy group, preferably two or more epoxy groups, and more preferably three or more epoxy groups. Since, as just described, the epoxy group-containing cross-linking agent has an epoxy group, which has excellent reactivity with a carboxy group contained in the specific resin, it can efficiently form a cross-linked structure together with the specific resin.

The epoxy group-containing cross-linking agent preferably has, in its molecule, at least one hydroxy group. Thus, the epoxy group-containing cross-linking agent can increase the affinity of the dispersion resin with the aqueous vehicle. As a result, the dispersion stability of the pigment particles in the aqueous vehicle can be further increased.

The epoxy group-containing cross-linking agent is preferably water-soluble. Specifically, the water solubility of the epoxy group-containing cross-linking agent is preferably not less than 80% and more preferably 100%. When the water solubility of the cross-linking agent is within the above range of values, the cross-linking efficiently progresses and the dispersion stability of the pigment particles in the aqueous vehicle can be further optimized.

The water solubility of the cross-linking agent used herein refers to, in the case of mixing of 10 g of the cross-linking agent with 90 g of water at 25° C., the rate (100×A/10 g) of the mass A of the cross-linking agent dissolved in the water relative to the total amount (10 g) of the cross-linking agent.

The epoxy group-containing cross-linking agent to be used is preferably sorbitol polyglycidyl ether, glycerol polyglycidyl ether, diglycerol polyglycidyl ether or polyglycerol polyglycidyl ether.

Examples of a manufacturer and a product name of the epoxy group-containing cross-linking agent include “DENACOL (registered trademark) EX-313”, “DENACOL (registered trademark) EX-512”, “DENACOL (registered trademark) EX-521”, “DENACOL (registered trademark) EX-614B”, and “DENACOL (registered trademark) EX-612”, all manufactured by Nagase ChemteX Corporation.

The chemical names, chemical formulas, epoxy equivalents, and water solubilities of the epoxy group-containing cross-linking agents having product names just described are shown in Table 1 below. In Table 1 below, “(1)+(2)” in Chemical Formula for the cross-linking agent (EX-313) means that the cross-linking agent contains a compound represented by the chemical formula (1) described below and a compound represented by the chemical formula (2) described below.

TABLE 1

| | | | Epoxy | Water |
|---|---|---|---|---|
| | | Chemical | Equivalent | Solubility |
| | Chemical Name | Formula | (g/eq.) | (% by mass) |
| EX-313 | glycerol polyglycidyl ether | (1) + (2) | 141 | 99 |
| EX-512 | polyglycerol polyglycidyl ether | (3) | 168 | 100 |
| EX-521 | polyglycerol polyglycidyl ether | (4) | 183 | 100 |
| EX-614B | sorbitol polyglycidyl ether | (5) | 173 | 94 |
| EX-612 | sorbitol polyglycidyl ether | (5) | 166 | 42 |

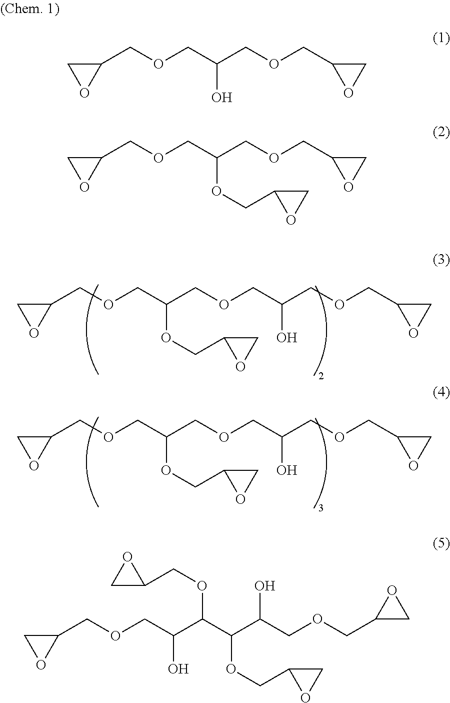

The epoxy group-containing cross-linking agent is particularly preferably a specific cross-linking agent that contains a polyfunctional epoxy compound having, in its molecule, two or more epoxy groups and one or more hydroxy groups and has a water solubility of 80% or more. When the epoxy group-containing cross-linking agent is the specific cross-linking agent, the dispersion stability of the pigment particles in the aqueous vehicle can be further increased.

The epoxy equivalent of the epoxy group-containing cross-linking agent is preferably not less than 100 g/eq. and not more than 10000 g/eq., and more preferably not less than 120 g/eq. and not more than 250 g/eq. If the epoxy equivalent of the cross-linking agent is too large, the epoxy groups act as water-soluble groups and, therefore, the cross-linking does not progress efficiently. If the epoxy equivalent is too small, the number of cross-linking sites is small and, therefore, the reduction in separation of the dispersion resin does not work sufficiently.

From the viewpoint of reactability and the storage stability of pigment particles, the weight average molecular weight of the epoxy group-containing cross-linking agent is preferably not less than 100 and not more than 1500.

As described previously, the specific resin contains a carboxy group derived from acrylic acid monomer or methacrylic acid monomer. The dispersion resin has a cross-linked structure derived from a carboxy group of the specific resin and an epoxy group of the epoxy group-containing cross-linking agent.

The cross-linking rate of the dispersion resin is preferably not less than 30% and not more than 90%, and more preferably not less than 40% and not more than 70%. By adjusting the cross-linking rate of the dispersion resin to not less than 30%, the separation of the dispersion resin from the pigment particles can be reduced, which can prevent aggregation of bare pigment particles. By adjusting the cross-linking rate of the dispersion resin to not more than 90%, the pigment particles can be given excellent dispersibility in the aqueous vehicle and this dispersibility can be maintained. Therefore, a dispersion resin having excellent solvent resistance and redispersibility can be provided.

The cross-linking rate of the dispersion resin refers to the apparent cross-linking rate calculated from the acid value of the specific resin and the epoxy equivalent of the epoxy group-containing cross-linking agent and can be calculated according to the following formula (1).

$$[ Math . 1 ]$$

$$Cross ‐ linking rate ( \% ) = ( number of mole epoxy equivalents of epoxy group ‐ containing cross ‐ linking agent ) / ( number of mole carboxy equivalents of specific resin ) \qquad ( 1 )$$

In the ink according to this embodiment, the content of dispersion resin is preferably not less than 0.5% by mass and not more than 10.0% by mass, and more preferably not less than 2.0% by mass and not more than 4.0% by mass. The content of dispersion resin in the pigment particle is preferably not less than 10% by mass and not more than 50% by mass, and more preferably not less than 20% by mass and not more than 30% by mass.

### [Specific Organic Solvent]

As described previously, the n-octanol/water partition coefficient of the specific organic solvent is not less than 0 and less than 0.55. Furthermore, in the ink according to this embodiment, the content of the specific organic solvent is not less than 25.0% by mass and not more than 35.0% by mass. Since the ink according to this embodiment contains the specific organic solvent within the above range of contents, the decrease in viscosity can be reduced and, therefore, the ink has excellent storage stability.

The type of the specific organic solvent to be used is not particularly limited so long as it is a solvent having an n-octanol/water partition coefficient in the above range, but the preferred specific organic solvent is 3-methyl-1,5-pentanediol (MPD), triethylene glycol monobutyl ether (BTG) or diethylene glycol monobutyl ether (BDG).

### [Surfactant]

The ink according to this embodiment preferably further contains a surfactant. The surfactant optimizes the penetration (wettability) of the ink according to this embodiment into a recording medium. Examples of the surfactant include an anionic surfactant, a cationic surfactant, and a non-ionic surfactant. The preferred surfactant is a non-ionic surfactant.

Examples of the non-ionic surfactant include polyoxyethylene dodecyl ether, polyoxyethylene hexadecyl ether, polyoxyethylene nonylphenyl ether, polyoxyethylene sorbitan monooleate ether, monodecanoyl sucrose, and an ethylene oxide adduct of acetylene glycol. The preferred non-ionic surfactant is an ethylene oxide adduct of acetylene glycol.

The content of surfactant in the ink according to this embodiment is preferably not less than 0.05% by mass and not more than 3.0% by mass, and more preferably not less than 0.1% by mass and not more than 0.5% by mass.

### [Other Components]

As necessary, the ink according to this embodiment may further contain a known additive (at least one of, for example, a dissolution stabilizer, an anti-drying agent, an antioxidant, a viscosity modifier, a pH adjuster, and a fungicide).

### Production Method of Ink

Next, a description will be given of an example of a method for producing the ink according to this embodiment. The method for producing the ink according to this embodiment includes a synthesis step of synthesizing a specific resin; a neutralization step of neutralizing the specific resin; a dispersion step of dispersing a pigment and the neutralized specific resin into water to prepare a dispersion liquid of pigment particles; a cross-linking step of adding an epoxy group-containing cross-linking agent into the dispersion liquid of pigment particles to cross-link the specific resin with the cross-linking agent, thus producing a dispersion resin; and an addition step of adding an aqueous vehicle and a specific organic solvent into the dispersion liquid of pigment particles after undergoing the cross-linking treatment to prepare an ink. The method for producing the ink according to this embodiment preferably further includes a centrifugation step of centrifuging the dispersion liquid of pigment particles after undergoing the cross-linking treatment to obtain a supernatant liquid and replacing the supernatant liquid with an aqueous medium.

### (Synthesis Step)

In the synthesis step, a specific resin is synthesized by copolymerizing α-methylstyrene monomer, styrene monomer, acrylic acid monomer or methacrylic acid monomer, and non-ionic monomer. Specifically, a polymerization initiator is added into a mixture liquid containing, in 100 parts by mass of a predetermined solvent, not less than 1 part by mass and not more than 65 parts by mass of α-methylstyrene monomer, not less than 1 part by mass and not more than 50 parts by mass of styrene monomer, not less than 10 parts by mass and not more than 40 parts by mass of acrylic acid monomer or methacrylic acid monomer, and not less than 1 part by mass and not more than 10 parts by mass of non-ionic monomer and the mixture liquid is heated to reflux, thus synthesizing a specific resin.

### (Neutralization Step)

In the neutralization step, the specific resin is neutralized. An example of the method for neutralizing the specific resin is a method of mixing the specific resin and an aqueous solution containing a basic compound (for example, KOH or NaOH). In the neutralization step, the specific resin is preferably neutralized not fully but partially. Specifically, the percentage of neutralization of the specific resin is not less than 20% and not more than 100%, and more preferably not less than 30% and not more than 60%.

### (Dispersion Step)

In the dispersion step, a dispersion liquid of pigment particles is prepared by dispersing a pigment and the neutralized specific resin into water. An example of a disperser for use in the dispersion step is a wet disperser, such as a medium disperser. The content of the neutralized specific resin in a solution for use in the dispersion step is, for example, not less than 4.0% by mass and not more than 25.0% by mass. The content of pigment in the solution for use in the dispersion step is, for example, not less than 1.0% by mass and not more than 20.0% by mass. The solution for use in the dispersion step may further contain a defoamer. The content of defoamer in the solution for use in the dispersion step is, for example, not less than 0.01% by mass and not more than 0.1% by mass. In the dispersion step, foreign material and coarse particles are preferably filtered out of the obtained dispersion liquid of pigment particles using a filter (having a pore diameter of, for example, 5 μm).

### (Cross-Linking Step)

In the cross-linking step, an epoxy group-containing cross-linking agent is added into the dispersion liquid of pigment particles. Thus, the carboxy group-containing specific resin contained in the dispersion liquid of pigment particles reacts with the epoxy group-containing cross-linking agent and is thus cross-linked. As a result, a dispersion resin is produced as a reaction product of the specific resin and the epoxy group-containing cross-linking agent. In the cross-linking step, it is preferred that the dispersion liquid of pigment particles after the addition of the epoxy group-containing cross-linking agent thereinto is heated while being stirred. The preferred heating temperature is, for example, not lower than 50° C. and not higher than 95° C. The preferred heating time is, for example, not less than 30 minutes and not more than eight hours.

### (Centrifugation Step)

In the centrifugation step, the dispersion liquid of pigment particles after undergoing the cross-linking treatment is subjected to centrifugation and the obtained supernatant liquid is replaced with an aqueous medium. Thus, free components contained in the aqueous medium of the dispersion liquid of pigment particles after undergoing the cross-linking treatment can be removed. In the conditions of the centrifugation treatment, for example, the rotational speed is preferably not less than 10000 rpm and not more than 100000 rpm. The centrifugation time is preferably not less than 12 hours and not more than 48 hours.

### (Addition Step)

In the addition step, an ink is prepared by adding an aqueous vehicle and a specific organic solvent into the dispersion liquid of pigment particles after undergoing the cross-linking treatment (or the dispersion liquid of pigment particles after undergoing the centrifugation treatment when the centrifugation treatment was done). In the addition step, as necessary, another component (specifically, at least one of a surfactant, a dissolution stabilizer, a humectant, a penetrant, and a viscosity modifier) may be further added. In the addition step, a mixture liquid obtained after the addition of the aqueous vehicle and the specific organic solvent is preferably stirred with a stirrer. Furthermore, foreign matter and coarse particles are preferably filtered out of the obtained ink using a filter (for example, a filter with a pore diameter of 5 μm or less).

Hereinafter, a description will be given of effects of the ink according to this embodiment with reference to examples. However, the present disclosure is not limited to the following examples.

### Production of Ink

Inks in Examples 1 to 8 (Ex. 1 to Ex. 8) and Comparative Examples 1 to 18 (CEx. 1 to CEx. 18) were produced as described below.

### [Synthesis of Resin 1]

An amount of 100.0 parts by mass of isopropyl alcohol and 250.0 parts by mass of methyl ethyl ketone were introduced into a four-necked flask (volume: 1000 mL) equipped with a stirrer, a nitrogen introduction tube, a condenser, and a dripping funnel. Separately, 20.0 parts by mass of styrene, 40.0 parts by mass of α-methylstyrene, 5.0 parts by mass of ethylene glycol acrylate, 25.0 parts by mass of methacrylic acid, and 0.3 parts by mass of azo-bis-isobutyronitrile (AIBN, a polymerization initiator) were mixed to prepare a mixed solution. Furthermore, 150.0 parts by mass of methyl ethyl ketone and 0.1 parts by mass of AIBN were mixed to prepare a methyl ethyl ketone solution.

Nitrogen gas was introduced into the above four-necked flask to place the interior of the flask under nitrogen atmosphere. While the contents of the four-necked flask were heated at 70° C. to reflux, the full amount of the mixed solution was added dropwise through the dripping funnel into the four-necked flask over two hours. After the addition of the mixed solution, the contents of the four-necked flask were further heated at 70° C. to reflux over six hours. Thereafter, while the contents of the four-necked flask were heated at 70° C. to reflux, the full amount of the methyl ethyl ketone solution was added dropwise through the dripping funnel into the four-necked flask over 15 minutes. After the addition of the methyl ethyl ketone solution, the contents of the four-necked flask were further heated at 70° C. to reflux over five hours. Next, the interior of the four-necked flask was subjected to decompression treatment, thus removing the solvents (methyl ethyl ketone and isopropyl alcohol) from the contents of the four-necked flask. Thus, Resin 1 was obtained.

### [Synthesis of Resins 2 to 13]

Resins 2 to 13 were synthesized in the same manner as in the method for synthesizing Resin 1 except that, in preparing a mixed solution, the type and amount of monomer used were changed as shown in Table 2 below.

### [Measurement of Acid Value]

Each of the synthesized resins (Resin 1 to Resin 13) was measured in terms of acid value in conformity with the method described in JIS K 0070:1992 (Test methods for acid value, saponification value, ester value, iodine value, hydroxy value and unsaponifiable matter of chemical products). The measurement results are shown in Table 2 below.

### [Measurement of Weight Average Molecular Weight]

Each of the resins (Resin 1 to Resin 13) was measured in terms of weight average molecular weight (Mw) under the conditions described below using gel permeation chromatography (GPC). The measurement results are shown in Table 2 below.

### (GPC Conditions)

Measurement device: “HLC-8020 GPC” manufactured by Tosoh Corporation
Column: “TSKgel SuperMultipore HZ-H” (semi-microcolumn with an inner diameter of 4.6 mm and a length of 15 cm) manufactured by Tosoh Corporation
Number of columns used: three
Eluent: tetrahydrofuran
Flow rate of eluate: 0.35 mL/min.
Amount of sample solution: 10 μL
Column temperature: 40° C.
Detector: RI (refractive index) detector

The calibration curves were created using monodisperse polystyrene standard samples (F-40, F-20, F-4, F-1, A-5000, A-2500, and A-1000) manufactured by Tosoh Corporation and n-propyl benzene.

### [Preparation of Resin Aqueous Solution 1]

### (Neutralization Treatment)

The synthesized Resin 1, potassium hydroxide, and water were mixed, thus preparing Resin aqueous solution 1. The prepared Resin aqueous solution 1 contained neutralized Resin 1. The amount of potassium hydroxide added was adjusted to an amount at which the percentage of neutralization of Resin 1 reached 60%. The amount of water added was adjusted to an amount at which the solid content concentration of the resin aqueous solution (i.e., the content of neutralized Resin 1) reached 30% by mass.

### [Preparation of Resin Aqueous Solutions 2 to 13]

Using each of the synthesized resins (each of Resins 2 to 13), Resin aqueous solutions 2 to 13 were prepared in the same manner as in the method for preparing Resin aqueous solution 1 except that the percentage of neutralization was changed as shown in Table 2 below.

TABLE 2

| Monomer Composition | Resin | Resin | Resin | Resin | Resin | Resin | Resin |
|---|---|---|---|---|---|---|---|
| (parts by mass) | 1 | 2 | 3 | 4 | 5 | 6 | 7 |
| styrene | 20 | 50 | 15 | 2 | 45 | 15 | 44 |
| α-methylstyrene | 40 | 20 | 15 | 37 | 8 | 65 | 18 |
| ethylene glycol acrylate | 5 | — | 1 | 6 | 0 | — | 10 |
| dipropylene glycol acrylate | — | 9 | — | — | 8 | 5 | — |
| acrylic acid | — | 13 | — | 23 | 40 | — | 10 |
| methacrylic acid | 25 | — | 20 | — | — | 15 | — |
| Acid Value(50-300 mgKOH/g) | 181 | 110 | 255 | 171 | 155 | 67 | 93 |
| Percentage of Neutralization | 60 | 90 | 30 | 70 | 70 | 80 | 80 |
| (20-100%) | | | | | | | |
| Molecular Weight(3000-18000) | 9600 | 10200 | 5200 | 9500 | 7600 | 6400 | 8700 |

| Monomer Composition | Resin | Resin | Resin | Resin | Resin | Resin |
|---|---|---|---|---|---|---|
| (parts by mass) | 8 | 9 | 10 | 11 | 12 | 13 |
| styrene | 63 | 0 | 40 | 30 | 50 | 54 |
| α-methylstyrene | 1 | 50 | 0 | 35 | 20 | 108 |
| ethylene glycol acrylate | 15 | 5 | 5 | 10 | — | 14 |
| dipropylene glycol acrylate | — | — | — | — | 9 | 0 |
| acrylic acid | — | 25 | 20 | 55 | 13 | 0 |
| methacrylic acid | 33 | — | — | 0 | — | 68 |
| Acid Value(50-300 mgKOH/g) | 204 | 243 | 239 | 329 | 110 | 181 |
| Percentage of Neutralization | 70 | 70 | 70 | 70 | 10 | 60 |
| (20-100%) | | | | | | |
| Molecular Weight(3000-18000) | 10100 | 8400 | 6300 | 12600 | 10200 | 26100 |

As shown in Table 2, Resins 1 to 7 were specific resins obtained by copolymerizing, in 100.0 parts by mass of isopropyl alcohol, not less than 1 part by mass and not more than 65 parts by mass of α-methylstyrene monomer, not less than 1 part by mass and not more than 50 parts by mass of styrene monomer, not less than 10 parts by mass and not more than 40 parts by mass of acrylic acid monomer or methacrylic acid monomer, and not less than 1 part by mass and not more than 10 parts by mass of non-ionic monomer, wherein the acid value was not less than 50 mgKOH/g and not more than 300 mgKOH/g, the weight average molecular weight was not less than 3000 and not more than 18000, and the percentage of neutralization was not less than 20% and not more than 100%.

On the other hand, Resins 8 to 13 were resins in which at least one of the monomer composition, the acid value, the weight average molecular weight, and the percentage of neutralization fell outside the above range (i.e., were not specific resins).

### [Preparation of Ink in Example 1]

### (Dispersion Treatment)

An amount of 15.0 parts by mass of carbon black (“Printex (registered trademark) 80” manufactured by Orion Engineered Carbons) as a pigment, Resin aqueous solution 1 (in an amount containing 4.5 parts by mass of Resin 1 in terms of solid content), 0.1 parts by mass of defoamer (“SN-DEFOAMER 1340” manufactured by San Nopco Limited), and ion-exchange water were mixed, thus obtaining a mixture. The amount of ion-exchange water added was adjusted to an amount at which the amount of the mixture reached 100 parts by mass.

The obtained mixture was subjected to dispersion treatment for four hours with a bead mill (“DYNO-MILL” manufactured by Willy A. Bachofen AG) which was a medium disperser. In the dispersion treatment, zirconia beads with a diameter of 0.5 mm were used as a medium. The loading rate of the medium was set to 60% by volume relative to the capacity of the vessel. The treatment temperature (chiller temperature) was set to 10° C. After the dispersion treatment, the medium was removed from the contents of the medium disperser, thus obtaining a dispersion liquid of pigment particles. The obtained dispersion liquid of pigment particles was filtered by a filter having a pore diameter of 5 μm, thus removing foreign matter and coarse particles from the dispersion liquid.

### (Cross-Linking Treatment)

A 1L three-necked flask equipped with a thermometer and stirring blades was used as a reactor. An amount of 100 g of dispersion liquid of pigment particles after undergoing the filtration was introduced into the reactor. The temperature of the contents of the reactor was maintained at 30° C. using a water bath. Next, 0.82 g of cross-linking agent (EX-313) was introduced into the reactor and the contents were stirred well. Next, the contents of the reactor were stirred at 150 rpm for an hour. Next, the contents of the reactor were increased in temperature to 80° C. at a rate of temperature increase of 0.5° C./min., with stirring at 250 rpm. Next, the contents of the reactor were stirred at 250 rpm for four hours while the temperature thereof was kept at 80° C. Thus, neutralized Resin 1 was cross-linked with the cross-linking agent (EX-313). Next, the contents of the reactor were cooled to room temperature. Thus, the dispersion liquid of pigment particles after undergoing the cross-linking treatment was obtained.

### (Centrifugation Treatment)

The dispersion liquid of pigment particles after undergoing the cross-linking treatment was transferred to a predetermined container. This container was placed in a centrifugal adhesion force measurement device (“NS-C100” manufactured by Nano Seeds Corporation). Using the centrifugal adhesion force measurement device, the dispersion liquid of pigment particles after undergoing the cross-linking treatment was subjected to centrifugation treatment at a rotational speed of 50000 rpm over 24 hours. After the centrifugation treatment, the supernatant liquid was removed from the container and the same volume of ion-exchange water as that of the removed supernatant liquid was then added into the container. In this manner, the dispersion liquid of pigment particles after undergoing the centrifugation treatment was obtained.

### (Addition Treatment)

The following components were introduced into the container to have Ink Formulation (1) shown in Table 3 below. Specifically, in Example 1, 40.0% by mass of dispersion liquid of pigment particles, 6.0% by mass of glycerin, 1.6% by mass of triethylene glycol monobutyl ether, 28.4% by mass of MPD, and 24.0% by mass of ion-exchange water were introduced into the container. The contents of the container were stirred at a rotational speed of 400 rpm using a stirrer (Three-One Motor BL-600″ manufactured by Shinto Scientific Co., Ltd.), thus obtaining a mixture liquid. The obtained mixture liquid was filtered by a filter (having a pore diameter of 5 μm). Thus, an ink A-1 in Example 1 (Ex. 1) was obtained.

### [Preparation of Inks in Examples 2 to 8 (Ex. 2 to 8) and Comparative Examples 1 to 18 (CEx. 1 to 18)]

Inks A-2 to A-26 in Examples 2 to 8 and Comparative Examples 1 to 18 were prepared in the same manner as in the method for preparing the ink A-1 in Example 1 except that the type of resin used, the type of cross-linking agent used, the type and amount of introduction of specific organic solvent in the addition treatment, and the ink formulation (Ink Formulation (1) or Ink Formulation (2) in Table 3) were changed as shown in Table 4 below.

In Table 4, “MPD” represents 3-methyl-1,5-pentanediol, “BTG” represents triethylene glycol monobutyl ether, “BDG” represents diethylene glycol monobutyl ether, “1,5-PD” represents 1,5-pentanediol, and “Gly” represents glycerin.

The n-octanol/water partition coefficient (LogP) of MPD is 0.03. The LogP of BTG is 0.51. The LogP of BDG is 0.3. The LogP of 1,5-PD is −0.49. The LogP of Gly is −1.7.

As seen from the above, MPD, BTG, and BDG were specific organic solvents having a LogP of not less than 0 and less than 0.55. On the other hand, 1,5-PD and Gly were organic solvents in which the LogP fell outside the above range (i.e., were not specific organic solvents).

TABLE 3

| | Resin Aqueous Solution | Ink Formulation | Ink Formulation |
|---|---|---|---|
| | Resin | (1) | (2) |
| Concentration | Dispersion liquid of pigment particles | 40.0 | 40.0 |
| (% by mass) | Glycerin | 6.0 | — |
| | Propylene glycol | — | 6.0 |
| | Triethylene glycol monobutyl ether | 1.6 | — |
| | Specific organic solvent (see Table 4) | see Table 4 | see Table 4 |
| | Ion-exchange water | rest | rest |
| | Total | 100 | 100 |

TABLE 4

| | | Preparation of Dispersion | | Preparation of Ink | | |
|---|---|---|---|---|---|---|
| | | Liquid | | | Solvent | |
| | | Resin | Cross-linking | Solvent | concentration | Ink |
| | | type | agent type | type | (% by mass) | formulation |
| Ex. 1 | A-1 | Resin 1 | EX-313 | MPD | 28.4 | Formula (1) |
| Ex. 2 | A-2 | Resin 2 | EX-512 | BTG | 25 | Formula (2) |
| Ex. 3 | A-3 | Resin 3 | EX-521 | BTG | 30 | Formula (1) |
| Ex. 4 | A-4 | Resin 1 | EX-614B | BDG | 28.4 | Formula (2) |
| Ex. 5 | A-5 | Resin 4 | EX-313 | MPD | 28.4 | Formula (1) |
| Ex. 6 | A-6 | Resin 5 | EX-313 | MPD | 28.4 | Formula (1) |
| Ex. 7 | A-7 | Resin 6 | EX-512 | BTG | 25 | Formula (2) |
| Ex. 8 | A-8 | Resin 7 | EX-521 | BTG | 30 | Formula (1) |
| CEx. 1 | A-9 | Resin 1 | EX-313 | MPD | 23.4 | Formula (1) |
| CEx. 2 | A-10 | Resin 2 | EX-512 | MPD | 38.4 | Formula (2) |
| CEx. 3 | A-11 | Resin 3 | EX-521 | BTG | 40 | Formula (1) |
| CEx. 4 | A-12 | Resin 4 | EX-313 | MPD | 38.4 | Formula (1) |
| CEx. 5 | A-13 | Resin 5 | EX-313 | MPD | 23.4 | Formula (1) |
| CEx. 6 | A-14 | Resin 6 | EX-512 | MPD | 38.4 | Formula (2) |
| CEx. 7 | A-15 | Resin 7 | EX-521 | BDG | 23.4 | Formula (1) |
| CEx. 8 | A-16 | Resin 8 | EX-512 | BDG | 28.4 | Formula (2) |
| CEx. 9 | A-17 | Resin 9 | EX-512 | MPD | 28.4 | Formula (2) |
| CEx. 10 | A-18 | Resin 10 | EX-313 | BTG | 25 | Formula (1) |
| CEx. 11 | A-19 | Resin 11 | EX-512 | BTG | 30 | Formula (2) |
| CEx. 12 | A-20 | Resin 12 | EX-521 | MPD | 23.4 | Formula (1) |
| CEx. 13 | A-21 | Resin 13 | EX-512 | MPD | 38.4 | Formula (2) |
| CEx. 14 | A-22 | Resin 1 | EX-612 | BDG | 23.4 | Formula (1) |
| CEx. 15 | A-23 | Resin 10 | EX-614B | 1,5-PD | 23.4 | Formula (2) |
| CEx. 16 | A-24 | Resin 9 | EX-512 | 1,5-PD | 28.4 | Formula (1) |
| CEx. 17 | A-25 | Resin 10 | EX-512 | Gly | 29.4 | Formula (2) |
| CEx. 18 | A-26 | Resin 13 | EX-521 | Gly | 34.4 | Formula (1) |

### Evaluations

Each of the inks in Examples 1 to 8 and Comparative Examples 1 to 18 was evaluated in terms of storage stability and reduction of nozzle clogging in the following manners. The evaluation results are shown in Table 5 below.

### [Storage Stability]

The initial viscosity VI of each ink at 25° C. was measured in conformity with the method described in JIS Z 8803:2011 (Methods for viscosity measurement of liquid). Next, approximately 30 g of the ink measured in terms of initial viscosity V1 was introduced into a 50 mL container. The container was subjected to heat treatment by leaving it to stand for a week in a thermostat bath set at an internal temperature of 80° C. Next, the container was taken out of the thermostat bath and cooled to room temperature (approximately 25° C.). In the same manner as in measuring the initial viscosity V1, the viscosity V2 of the ink after undergoing the heat treatment was measured. Using the initial viscosity V1 and the viscosity V2 after the treatment, the viscosity change rate was determined from the formula (2) below. The obtained viscosity change rate was used as an evaluation value for storage stability. Each ink was evaluated in terms of storage stability in accordance with the criteria below.

$$[ Math . 2 ]$$

$$Viscosity change rate ( \% ) = ( V 1 - V 2 ) / V 1 \times 100 \qquad ( 2 )$$

### (Storage Stability Criteria)

“Circle” symbol (good): The viscosity change rate was less than ±3%.
“Cross” symbol (poor): The viscosity change rate was ±3% or more.

### [Nozzle Clogging]

In the evaluation of reduction of nozzle clogging, ink-jet matte paper (“SuperFine Paper” manufactured by Seiko Epson Corporation) was used as evaluation paper. As an apparatus for evaluation, a line head-mounted ink-jet recording apparatus (a test apparatus produced by KYOCERA Document Solutions Inc.) was used. Each of the inks in Examples 1 to 8 and Comparative Examples 1 to 18 as subjects to evaluation was loaded into a black ink tank of the apparatus for evaluation.

Using the apparatus for evaluation, a solid image with 150 mm×200 mm was continuously formed on 100 sheets of evaluation paper. Next, purge processing for purging ink from the recording head of the apparatus for evaluation was done. Next, wiping processing for wiping the ink ejection surface of the recording head of the apparatus for evaluation with a cleaning wiper was done. Hereinafter, the operation for cleaning the recording head by the purge processing and the wiping processing is referred to as cleaning processing.

Next, using the apparatus for evaluation, a nozzle check pattern image was formed on a sheet of evaluation paper. As a result, it was confirmed that in all the cases where the respective subject inks were used, ink had been ejected through all the nozzles (7968 nozzles). In other words, the number of nozzles caused clogging (hereinafter, referred to as “non-ejectable nozzles”) was zero. Next, the recording head of the apparatus for evaluation was subjected to the cleaning processing again. Next, the apparatus for evaluation was allowed to stand for seven days with its recording head uncapped. Next, the recording head of the apparatus for evaluation was subjected to the cleaning processing again.

Next, using the apparatus for evaluation, a nozzle check pattern image was formed as an evaluation image on a sheet of evaluation paper. The formed evaluation image was observed and the percentage of the number of non-ejectable nozzles with respect to the total number of nozzles (7968 nozzles) of the recording head of the apparatus for evaluation was calculated. The calculated percentage of the number of non-ejectable nozzles was used as an evaluation value for reduction of nozzle clogging. Each ink was evaluated in terms of reduction of nozzle clogging in accordance with the following criteria.

### (Nozzle Clogging Reduction Criteria)

“Circle” symbol (good): The evaluation value was less than 10%.
“Cross” symbol (poor): The evaluation value was 10% or more.

TABLE 5

| | | Storage Stability | | Nozzle Clogging | |
|---|---|---|---|---|---|
| | | Determination | Results Detail | Determination | Results Detail |
| Ex. 1 | A-1 | ∘ | 2.7% | ∘ | 6% |
| Ex. 2 | A-2 | ∘ | 2.9% | ∘ | 5% |
| Ex. 3 | A-3 | ∘ | 2.8% | ∘ | 8% |
| Ex. 4 | A-4 | ∘ | 2.3% | ∘ | 7% |
| Ex. 5 | A-5 | ∘ | 2.8% | ∘ | 7% |
| Ex. 6 | A-6 | ∘ | 2.7% | ∘ | 8% |
| Ex. 7 | A-7 | ∘ | 2.8% | ∘ | 5% |
| Ex. 8 | A-8 | ∘ | 2.9% | ∘ | 6% |
| CEx. 1 | A-9 | x | 5.5% | ∘ | 7% |
| CEx. 2 | A-10 | x | 3.7% | ∘ | 6% |
| CEx. 3 | A-11 | x | 3.2% | ∘ | 8% |
| CEx. 4 | A-12 | x | 4.5% | ∘ | 7% |
| CEx. 5 | A-13 | x | 5.4% | ∘ | 8% |
| CEx. 6 | A-14 | x | 4.6% | ∘ | 5% |
| CEx. 7 | A-15 | x | 3.8% | ∘ | 6% |
| CEx. 8 | A-16 | ∘ | 2.4% | x | 20% |
| CEx. 9 | A-17 | ∘ | 2.8% | x | 22% |
| CEx. 10 | A-18 | ∘ | 2.9% | x | 26% |
| CEx. 11 | A-19 | ∘ | 2.7% | x | 12% |
| CEx. 12 | A-20 | x | 6.5% | x | 19% |
| CEx. 13 | A-21 | x | 4.4% | x | 25% |
| CEx. 14 | A-22 | x | 3.5% | x | 16% |
| CEx. 15 | A-23 | x | 10.7% | x | 26% |
| CEx. 16 | A-24 | x | 5.1% | x | 22% |
| CEx. 17 | A-25 | x | 10.8% | x | 24% |
| CEx. 18 | A-26 | x | 6.3% | x | 25% |

### (Examples 1 to 8)

In each of the inks in Examples 1 to 8, the dispersion resin was a cross-linked product made of: a neutralized product of a specific resin (specifically, one of Resins 1 to 7); and a specific cross-linking agent (specifically, one of EX-313, EX-512, EX-521, and EX-614B). As a result, the inks in Examples 1 to 8 were determined to have excellent initial dispersibility and dispersion stability and to be good in terms of reduction of nozzle clogging.

Furthermore, the inks in Examples 1 to 8 were inks containing a specific organic solvent (specifically, one of MPD, BTG, and BDG) in an amount of not less than 25.0% by mass and not more than 35.0% by mass. As a result, the decrease in ink density was reduced as for these inks and these inks were determined to be good in terms of storage stability.

### (Comparative Examples 1 to 7)

In each of the inks in Comparative Examples 1 to 7, the dispersion resin was a cross-linked product made of: a neutralized product of a specific resin (specifically, one of Resins 1 to 7); and a specific cross-linking agent (specifically, one of EX-313, EX-512, and EX-521). As a result, the inks in Comparative Examples 1 to 7 were determined to have excellent initial dispersibility and dispersion stability and to be good in terms of reduction of nozzle clogging.

On the other hand, although the inks in Comparative Examples 1 to 7 contained a specific organic solvent (specifically, one of MPD, BTG, and BDG), the content of the specific organic solvent fell outside the above range. As a result, the ink density decreased and, therefore, these inks were determined to be poor in terms of storage stability.

### (Comparative Examples 8 to 11)

In each of the inks in Comparative Examples 8 to 11, the dispersion resin was a cross-linked product made of: a neutralized product of a resin (specifically, one of Resins 8 to 11) other than a specific resin; and a specific cross-linking agent (specifically, EX-313 or EX-512). As a result, the inks in Comparative Examples 8 to 11 were determined to have poor dispersion stability and to be poor in terms of reduction of nozzle clogging.

On the other hand, the inks in Comparative Examples 8 to 11 were inks containing a specific organic solvent (specifically, one of MPD, BTG, and BDG) in an amount of not less than 25.0% by mass and not more than 35.0% by mass. As a result, the decrease in ink density was reduced as for these inks and these inks were determined to be good in terms of storage stability.

### (Comparative Examples 12 and 13)

In each of the inks in Comparative Examples 12 and 13, the dispersion resin was a cross-linked product made of: a neutralized product of a resin (specifically, Resin 12 or 13) other than a specific resin; and a specific cross-linking agent (specifically, EX-521 or EX-512). As a result, the inks in Comparative Examples 12 and 13 were determined to have poor dispersion stability and to be poor in terms of reduction of nozzle clogging.

Furthermore, although the inks in Comparative Examples 12 and 13 contained a specific organic solvent (specifically, MPD), the content of the specific organic solvent fell outside the above range. As a result, the ink density decreased and, therefore, these inks were determined to be poor in terms of storage stability.

### (Comparative Example 14)

In the ink in Comparative Example 14, the dispersion resin was a cross-linked product made of: a neutralized product of a specific resin (specifically, Resin 1); and an epoxy group-containing cross-linking agent (specifically, EX-612 having a water solubility of less than 80%) other than a specific cross-linking agent. Therefore, compared to the inks into which a specific cross-linking agent was added, the hydrophilicity of the dispersion resin was considered to be lower and the dispersion stability of pigment particles was considered to be inferior. As a result, this ink was determined to be poor in terms of reduction of nozzle clogging.

Furthermore, although the ink in Comparative Example 14 contained a specific organic solvent (specifically, BDG), the content of the specific organic solvent fell outside the above range. As a result, the ink density decreased and, therefore, this ink was determined to be poor in terms of storage stability.

### (Comparative Examples 15 to 18)

In each of the inks in Comparative Examples 15 to 18, the dispersion resin was a cross-linked product made of: a neutralized product of a resin (specifically, one of Resins 9, 10, and 13) other than a specific resin; and an epoxy group-containing cross-linking agent (specifically, one of EX-512, EX-521, and EX-614B). As a result, the inks in Comparative Examples 15 to 18 were determined to have poor dispersion stability and to be poor in terms of reduction of nozzle clogging.

Furthermore, the inks in Comparative Examples 15 to 18 were inks containing no specific organic solvent. Specifically, the inks in Comparative Examples 15 to 18 were inks containing an organic solvent (specifically, 1,5-PD or Gly) other than a specific organic solvent. As a result, the ink density decreased and, therefore, these inks were determined to be poor in terms of storage stability.

As described previously, the inks in Examples 1 to 8 were determined to be good in terms of both of reduction of nozzle clogging and storage stability. On the other hand, any of the inks in Comparative Examples 1 to 18 was not determined to be good in terms of both of reduction of nozzle clogging and storage stability.

### INDUSTRIAL APPLICABILITY

The ink according to this embodiment can be used in order to form an image.

While the present disclosure has been described in detail with reference to the embodiments thereof, it would be apparent to those skilled in the art that the various changes and modifications may be made therein within the scope defined by the appended claims.

What is claimed is:

1. An ink-jet ink containing an aqueous vehicle, pigment particles dispersed in the aqueous vehicle, and a specific organic solvent,
the pigment particle containing a pigment and a dispersion resin,
the dispersion resin being a cross-linked product made of: a neutralized product of a specific resin obtained by copolymerizing, in 100 parts by mass of a predetermined solvent, not less than 1 part by mass and not more than 65 parts by mass of α-methylstyrene monomer, not less than 1 part by mass and not more than 50 parts by mass of styrene monomer, not less than 10 parts by mass and not more than 40 parts by mass of acrylic acid monomer or methacrylic acid monomer, and not less than 1 part by mass and not more than 10 parts by mass of non-ionic monomer; and an epoxy group-containing cross-linking agent,
the specific resin having an acid value of not less than 50 mgKOH/g and not more than 300 mgKOH/g,
the specific resin having a weight average molecular weight of not less than 3000 and not more than 18000,
the specific resin having a percentage of neutralization of not less than 20% and not more than 100%, and
the specific organic solvent having an n-octanol/water partition coefficient of not less than 0 and less than 0.55,
wherein a content of the specific organic solvent is not less than 25.0% by mass and not more than 35.0% by mass.

2. The ink-jet ink according to claim 1, wherein the epoxy group-containing cross-linking agent is a specific cross-linking agent that contains a polyfunctional epoxy compound having, in a molecule thereof, two or more epoxy groups and one or more hydroxy groups and has a water solubility of 80% or more.

3. The ink-jet ink according to claim 1, wherein the dispersion resin has a cross-linking rate of not less than 30% and not more than 90%.

4. The ink-jet ink according to claim 1, wherein the specific organic solvent is 3-methyl-1,5-pendanediol (MPD), triethylene glycol monobutyl ether (BTG) or diethylene glycol monobutyl ether (BDG).

5. A method for producing an ink-jet ink, the method comprising:
a synthesis step of copolymerizing, in 100 parts by mass of a predetermined solvent, not less than 1 part by mass and not more than 65 parts by mass of α-methylstyrene monomer, not less than 1 part by mass and not more than 50 parts by mass of styrene monomer, not less than 10 parts by mass and not more than 40 parts by mass of acrylic acid monomer or methacrylic acid monomer, and not less than 1 part by mass and not more than 10 parts by mass of non-ionic monomer, thus synthesizing a specific resin;
a neutralization step of neutralizing the specific resin to give a percentage of neutralization of not less than 20% and not more than 100%;
a dispersion step of dispersing a pigment and the neutralized specific resin into water to prepare a dispersion liquid of pigment particles;
a cross-linking step of adding an epoxy group-containing cross-linking agent into the dispersion liquid of pigment particles to cross-link the specific resin with the cross-linking agent; and
an addition step of adding an aqueous vehicle and a specific organic solvent having an n-octanol/water partition coefficient of not less than 0 and less than 0.55 into the dispersion liquid of pigment particles after undergoing the cross-linking step to give a content of the specific organic solvent of not less than 25.0% by mass and not more than 35.0% by mass.
